(19) United States
(12) Patent Application Publication
(10) Pub. No.: US 2008/0128931 A1
(43) Pub. Date: Jun. 5, 2008

(54) Method for preparing nanocomposite ZnO-SiO2 fluorescent film by sputtering

(75) Inventors: Tsung-Eong Hsieh, Hsinchu (TW); Yu-Yun Peng, Hsinchu (TW)

Correspondence Address: BACON & THOMAS, PLLC, 625 SLATERS LANE, FOURTH FLOOR, ALEXANDRIA, VA, 22314, US

(73) Assignee: National Chiao Tung University, Hsinchu (TW)

(21) Appl. No.: 11/606,096

(22) Filed: Nov. 30, 2006

(51) Int. Cl. C09K 11/54; B29C 43/00

(52) U.S. Cl. 264/21

(57) ABSTRACT

A method for preparing nanocomposite ZnO—SiO₂ fluorescent thin film by magnetron sputtering is proposed. ZnO is formed as nano-sized crystalline particles uniformly dispersed in the amorphous SiO₂ matrix after the sputtering. The photoluminescence (PL) revealed that the spectra consisted of three emission bands, violet, blue and green-yellow and the mixed light turns out to be white. By adjusting the ZnO doping concentration, the relative emission intensities of the three bands can be modulated so that white light with different color temperatures can be obtained. By the invention, the whole process comprised of only one single-layer deposition that can be applied on any substrate.

### BACKGROUND OF THE INVENTION

1. Field of the Invention

The invention relates to preparing ZnO—SiO₂ fluorescent film, more particularly for preparing nanocomposite ZnO—SiO₂ fluorescent film by sputtering.

2. Description of the Prior Art

In recent years, since the optoelectronic industry is rapidly developed, many kinds of optoelectronic device components are proposed and applied widely to that including the illumination, the flat panel displays (FPDs), the optical communication and so on. In the illumination and the FPDs, since 1996, Mr. Nakamura at Nichia Company has detruded the GaN blue light emitting diode (LED), which excited YAG yellow fluorescent powders for white-light emission, that has opened the global white light source revolution.

For many kinds of white-light emission technologies, from the LED through the thin film electroluminescence components to the field emission display components, related researches and development are still in progress. It is, not only expecting to displace the low efficiency, high electricity consumption, short life and easy broken white incandescent light sources, but also for improving photoelectric transferring, decreasing thermo energy, reducing the impact of global green-house effect and environment pollution problems caused by the mercury-contained rubbish. The light-emitting devices can be applied to many sorts of functional light sources including the electric equipments, the traffic light sources and the driving control panels, also can displace the traditional backlight source of all-size FPDs in order to reduce the volume of monitors, so that finally can be highest electricity-saving efficiency.

Whatever white-light emission elements or white backlight sources for the displays, it is obviously that wherein the most crucial point would be the collected fluorescent materials. The light-emission characteristics of fluorescent depend on the material compositions, purity level, temperature and microstructure. Different host of fluorescents often depend on the activator, co-activator, and sensitizer to absorb energy or transfer energy to achieve high luminescent efficiency.

Right now in the related market, the most general frameworks for white-light components utilize a short-wavelength light-emitting source exciting a fluorescent to emit white light. For example, GaN blue LED excites the YAG fluorescent powders to form white light, that is a sort of white-light LED with highest transferring efficiency than other LEDs. However, even this can meet the requisite of high brightness, the cost for YAG fluorescent powders still are very high and photo-electricity transferring efficiency are still not optimized. The above tech can be applied for the general illuminations but not suitable for the display panels.

The ZnO—SiO₂ nanocomposite films are composed of ZnO nanocrystallines embedded in amorphous SiO₂ matrix in which the composition is controlled by the target preparation methods. There are two traditional target preparation methods able to fabricate ZnO—SiO₂ nanocomposite films effectively. The two methods are described as follow:

### 1. Target Preparation Method by Sol-Gel Process

TEOS is used as the precursor for SiO₂ formation and ZnO powder are added into the SiO₂ gel during the gelation. After the stirring, de-solvent and drying process, the ZnO—SiO₂ composite target is prepared. The composition can be controlled by the amount of the chemical reaction of SiO₂ formation and the ZnO powder added.

### 2. Target Preparation Method by Powder Sintering

The micrometer-scale ZnO and SiO₂ powder are first dried at temperature of about 70° C. to 120° C. for 10 hours to 13 hours and then uniformly mixed. The mixed powders are put into the target mold and then cold-pressed into a dense bulk. The green target is then sintered at temperature of 1300° C. for 12 hours. The composite target is then formed. The composition is controlled by calculation the weight percent of ZnO and SiO₂ powder mixed.

Furthermore, for understanding some conventional references, as United State of American patents are search as the following list:

U.S. Pat. No. 6,294,800, “Phosphors for white light generation from UV emitting diodes”; U.S. Pat. No. 6,501,100, “White light emitting phosphor blend for LED devices”; U.S. Pat. No. 6,522,065, “Single phosphor for creating white light with high luminosity and high CRI in a UV led device”; U.S. Pat. No. 6,521,211, “Methods of imaging and treatment with targeted compositions”; U.S. Pat. No. 6,765,237, “White light emitting device based on UV LED and phosphor blend”; U.S. Pat. No. 6,853,131, “Single phosphor for creating white light with high luminosity and high CRI in a UV LED device”; U.S. Pat. No. 6,939,481, “White light emitting phosphor blends for LED devices”; U.S. Pat. No. 6,982,045, “Light emitting device having silicate fluorescent phosphor” and U.S. Pat. No. 6,942,932, “Phosphor and EL panel”. However, after carefully repeated review, these references are all not related to this invention.

### SUMMARY OF THE INVENTION

In accordance with the present invention, a method for preparing nanocomposite ZnO—SiO₂ fluorescent thin film by sputtering is provided as follows. In addition, the foregoing, as well as additional objects, features and advantages of the invention will be more readily apparent from the following detailed description, which proceeds with reference to the accompanying drawings.

The invention, as a method for preparing the nanocomposite ZnO—SiO₂ fluorescent thin film by sputtering will be disclosed as follows.

ZnO powder are first dried at temperature of about 70° C. to 120° C. for 10 hours to 13 hours and then cold-pressed into small pastille as the dopant source. Next, the pastilles are placed onto the SiO₂ target during the sputtering.

By changing the plurality of the area ratio, the composition of the film deposited can be controlled. Therefore, the deposited thin film can be excited by ultraviolet (UV) to emit white light. Other unique features of this method are no substrate heating and post-annealing required for thin film preparation.

By the invention, the ZnO can be formed as nano-sized crystalline particles about 1 nm to 7 nm in diameter uniformly dispersed in the amorphous SiO₂ matrix after the sputtering. By adjusting the ZnO doping concentration, the relative emission intensities of the three emission bands can be modulated so that white light with different color temperatures can be obtained.

The nanocomposite ZnO—SiO₂ thin films fabricated by these methods not only possess excellent chemical and thermal stability but also high optical transmittance.

The photoluminescence (PL) revealed that the spectra consisted of three emission bands, violet, blue and green-yellow and the mixed light turns out to be white.

The whole process comprised of only one single-layer deposition that can be applied on any substrate. The cost is low and only simple raw material is required.

It is worth of noting that the well dispersed nanocrystalline particles inside the amorphous transparent SiO₂ matrix can solve the light mixing problems of the non-uniform particle size, poor dispersion, aggregation, etc., occurred in the traditional fluorescent powder systems.

The thin film grown by these methods can be easily integrated with other optoelectronic device processes or used as the active layer or the surface coating.

It is expected that ZnO—SiO₂ nanocomposite thin films possess a great potential to serve as the fluorescence system and the fluorescence thin film in light emitting devices and flat FPDs with improved optical transfer efficiency and simple fabrication process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the flow chart of producing process schematically illustrating the embodiment of the invention.

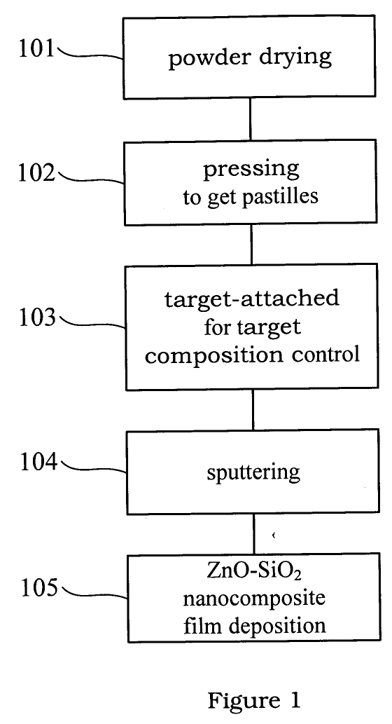

### DESCRIPTION OF THE PREFERRED EMBODIMENT

The following is a description of the present invention and the invention will firstly be described with reference to one exemplary structure. Some variations will then be described as well as advantages of the present invention. A preferred method of fabrication will then be discussed, also, an alternate, asymmetric embodiment will then be described along with the variations in the process flow to fabricate this embodiment.

The invention for target preparation method is able to fabricate ZnO—SiO₂ nanocomposite films effectively. The ZnO—SiO₂ nanocomposite films are composed of ZnO nanocrystallines embedded in amorphous SiO₂ matrix in which the composition is controlled by the target preparation method. Especially, in this invention, white-light emitting ZnO—SiO₂ nanocomposite film is prepared using radio-frequency (RF) magnetron sputtering without substrate heating and post thermal treatment.

Firstly, powder drying is processed for the plurality of the zinc oxide (ZnO) powders, as FIG. 101, until all powders would be dried up. Here, the drying temperature is about 70° C. to 120° C. and drying time is about 10 hours to 13 hours.

Secondly, FIG. 102 illustrates that pressing process for the plurality of the ZnO powders will be carried out after powder drying, so that the plurality of the ZnO powders will be cold-pressed into small pastilles as the plurality of the ZnO powder pastilles, also for the dopant source.

Next, FIG. 103 shows that the ZnO pastilles are attached onto the SiO₂ target (e.g., cold-pressing SiO₂ powder target or quartz target) at the right setting position of the sputtering machine as the target-attached process. Also, the composition ratio for the plurality of ZnO powder pastilles to SiO₂ target as the sputtering target can be clearly controlled and calculated by the previous process. Especially, by adjusting the ratio between the plurality of the ZnO powder pastilles to the plurality of SiO₂ target can emit the different lighting color. The main reason can be described as follows.

Sequentially, FIG. 104 describes that the plurality of ZnO powder pastilles will be sputtered simultaneously with the plurality of SiO₂ target, as the dopant process. The sputtering process is carried out in the vacuum with the background pressure better than 10⁻⁶ torr. The working pressure is maintained at argon (Ar) ambient pressure of about 1 mtorr and the sputtering powers vary from 50 W to 300 W. The deposited films thus contain nano-sized ZnO crystallines uniformly distributed in the amorphous SiO₂ matrix with the average diameter changing from 1 nm to 7 nm. Especially, sputtering can be carried out at the condition of 100 W RF power at 5 mtorr Ar pressure. Glasses are used as substrates and all the deposited layers are approximately 140 nm thick. No substrate heating upon deposition or post-growth annealing is carried out.

Finally, as FIG. 105, ZnO—SiO₂. nanocomposite film deposition is formed. Thus, the ZnO can be formed as nano-sized crystalline particles changing between about 1 nm to 7 nm in diameter uniformly dispersed in the amorphous SiO₂ matrix after the sputtering.

The microstructure of the sample is characterized by x-ray diffraction (XRD, MacScience M18XHF-SRA, with λ=0.154 nm) and transmission electron microscopy (TEM, Philips TECNAI 20). Also, the composition is examined by x-ray photoemission spectroscopy (XPS) with an Mg—K_{α} source (American Physical Electronics ESCA PHI 1600). The photoluminance (PL) spectra are measured at room temperature using a 325 nm He—Cd laser.

Also, the microstructure analysis revealed that as the ZnO dopant concentration increases, the size of the ZnO nanocrystalline increases and the distance between the nanoparticles decreases. Especially the number of ZnO powder pastilles can be adjusted to control the ZnO content in the ZnO—SiO₂ nanocomosite films.

ZnO normally is a wide-band gap semiconductor (E_{g}=3.25 to 3.5 eV) with many desirable physical properties. In addition to emission in UV region, the ZnO also emits a broad luminescence emission in the green-yellow region. Its large exciton binding energy (59 meV) gives rise to the high efficiency exciton emission at room temperature.

By adjusting the ZnO doping concentration, the relative emission intensities of the three bands, i.e., the violet, blue and green-yellow emissions, can be modulated so that white light with different color temperatures can be obtained. The PL spectra showed that the light emitted by the ZnO—SiO₂ nanocomosite films excited by 325 nm He—Cd laser consisted three emission bands as stated above. The color of the light mixed by the three emission bands can changed from white-blue, nearly white to white-yellow. Therefore, by the chromaticity variation of the luminescent light, the ZnO—SiO₂ nanocomposite films can be divided into three categories:
1. The composite film containing the ZnO nanocrystalline with the diameter smaller than 3.5 nm or the composition, Zn<2.15 at % emits white-blue light.
2. The composite film containing the ZnO nanocrystalline with the diameter between 3.5 and 5.8 nm or the composition, 2.15 at %<Zn<8.8 at. %, emits nearly-white light.
3. The composite film containing the ZnO nanocrystalline with the diameter larger than 5.8 nm or the composition, Zn>8.8 at % emits white-yellow light.

It is understood that various modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A method for preparing a nanocomposite ZnO—SiO₂ fluorescent film by sputtering, comprising:
powder drying a plurality of zinc oxide (ZnO) powders;
pressing the plurality of ZnO powders so that the plurality of ZnO powders being into small pastilles as the plurality of ZnO powder pastilles;
a plurality of silicon oxide (SiO₂) powders are provided as a target which being the target-attached process as controlling a composition amount for the plurality of SiO₂ powders as target composition control;
the plurality of ZnO powder pasties being sputtered into the plurality of SiO₂ target as a dopant process; and
forming a ZnO—SiO₂ nanocomposite film deposition so that preparing the nanocomposite ZnO—SiO₂ fluorescent film by sputtering is carried out.

2. The method according to claim 1, wherein said the ZnO nanocrystalline is about from 1 nm to 7 nm.

3. The method according to claim 1, wherein temperature for said powder drying is about 70° C. to 120° C.

4. The method according to claim 1, wherein time for said powder drying is about 10 hours to 13 hours.

5. The method according to claim 1, wherein said pressing comprises cold pressing.

6. The method according to claim 1, wherein said nanocomposite ZnO—SiO₂ fluorescent film comprises the ZnO nanocrystalline with the diameter smaller than 3.5 nm or the composition, Zn<2.15 at %, emitting white-blue light.

7. The method according to claim 1, wherein said nanocomposite ZnO—SiO₂ fluorescent film comprises the ZnO nanocrystalline with the diameter between 3.5 and 5.8 nm or the composition, 2.15 at. %<Zn<8.8 at %, emitting nearly-white light.

8. The method according to claim 1, wherein said nanocomposite ZnO—SiO₂ fluorescent film comprises the ZnO nanocrystalline with the diameter larger than 5.8 nm or the composition, Zn>8.8 at. %, emitting white-yellow light.
